(19) United States
(12) Patent Application Publication
(10) Pub. No.: US 2008/0152779 A1
(43) Pub. Date: Jun. 26, 2008

(54) Instant Product

(76) Inventors: Evelyne De Groote, Zurich (CH); Tomas Keme, Aarau (CH); Jorg Kowalczyk, Eisenborg/Steinborn (DE)

Correspondence Address: OSTROLENK FABER GERB & SOFFEN, 1180 AVENUE OF THE AMERICAS, NEW YORK, NY, 100368403, US

(21) Appl. No.: 11/911,182

(22) PCT Filed: Apr. 10, 2006
(86) PCT No.: PCT/EP2006/003253

§ 371 Date: Jan. 4, 2008

(30) Foreign Application Priority Data
Apr. 15, 2005 (DE) 10 2005 017 613.5
Apr. 20, 2005 (EP) 05008627.1

(51) Int. Cl. A23P 1/02; A23F 5/38; A23F 3/32; A23G 1/56; A23L 1/00

(52) U.S. Cl. 426/593; 426/465; 426/445; 426/594; 426/597; 426/599; 426/589; 426/650; 426/655; 426/531; 426/658

(57) ABSTRACT

The invention relates to shaped instant pieces which are suitable for producing an instant food or instant drug, in particular an instant drink, which is produced from an instant composition, and to processes for producing the shaped instant pieces of an instant composition.

Instant products, in particular for producing cold or hot drinks such as coffee, cocoa, chocolate, tea, juices, soft drinks or lemonades, are known. Known instant products are food products in highly soluble powder form or usually disintegrant-containing tablet form. Pulverulent instant products are packaged in air- and/or water-tight bags or tins. These instant products charged into packaging have the disadvantage that, on account of their pulverulent form, they can be readily spilt in use. In addition, pulverulent instant products are difficult to meter. End consumers must determine an appropriate dosage themselves in combination with the spoon used for the metering. However, if premetering via an instant product in tablet form proceeds, it is necessary to ensure by additional measures that the tableted product does actually dissolve in an appropriate time. Known compacted or tableted instant products, for dissolution in a liquid, such as, for example, water or milk, therefore receive at least one disintegrant. Disintegrants frequently have disadvantageous chemical, physiological or organoleptic properties. The market acceptance of tableted instant products, especially for preparing hot drinks and milk drinks, is therefore low. Also, known instant products are frequently not admixed with sugar or sugar-like sweeteners of the desired amount, so that on their use, in addition, sugar or another sweetener must be used.

Proceeding from the prior art, the problem underlying the invention is to provide a remedy and to develop the instant product of the type in question in such a manner that it can be used without the abovementioned disadvantages. The technical problem, in particular, underlying the invention is to provide soluble instant products which are simple to meter. In addition, in particular, the technical problem underlies the invention of providing non-pulverulent instant products which need not obligatorily contain a disintegrant for dissolving the instant product.

The present invention solves the underlying technical problem essentially by a process for producing a shaped instant piece of an at least partially water-soluble instant composition, at least comprising the steps:

a) providing the instant composition, wherein the instant composition is first pulverulent or is present in granule or grain form;

b) shaping the instant composition, wherein the instant composition, on shaping, has a water content of 0.01 to 40% by weight, preferably of 0.01 to 30% by weight (based on the total weight), and

c) drying the shaped instant composition under reduced pressure, that is to say under vacuum, preferably at elevated temperature.

Preferably, in step a), mixing of the instant composition takes place, that is to say particularly mingling, stirring, blending. Shaping in the present case is taken to mean shaping by pressing, extrusion or the like, but also charging into or packaging in a vessel, a mold or mold with or without subsequent compaction.

The present invention also solves the underlying technical problem by shaped instant pieces which are producible or are produced by the process according to the invention.

It has surprisingly been found that drying an instant composition having a water content of 0.01% by weight or more and 40% by weight or less (based on the total weight) under reduced atmospheric pressure vacuum leads to the formation of dry storable shaped instant pieces which have a porous structure or matrix. A liquid in which the instant product is dissolved can penetrate very well into this porous structure or matrix, as a result of which the liquid in the shaped instant piece acts similarly to a disintegrant. The porosity of the shaped instant piece significantly improves the dissolution behavior, especially owing to the capillary action of the structure. The disintegration times of the shaped instant pieces are greatly reduced compared with known tableted, compacted or pulverulent instant products.

In addition, it has surprisingly been found that it is possible to dry shaped moist instant compositions in such a manner that the drying time can be shortened and the drying temperature lowered, which leads to quality advantages, for example with respect to aroma and taste of the components.

In the context of the invention, a soluble instant composition is taken to mean a composition in which at least one component is present which is soluble in a liquid, in particular in an aqueous liquid. Preferably, the instant composition contains only soluble components, so that it dissolves rapidly and virtually residue-free. Instant compositions are suitable for immediate consumption, that is to say particularly for immediate dissolution in a liquid, preferably in an aqueous liquid. Preferably, an instant composition is pulverulent, granular, or grainy.

In the context of the present invention, a shaped instant piece is taken to mean an instant product in which individual particles of the instant composition, owing to shaping and subsequent drying, adhere to one another in such a manner that as a result the instant product has the shape of a piece, in particular a three-dimensional figure, for example cuboid, cube, sphere, cylinder, lens, egg, ring, roller, cone, tetrahedron, octahedron, playing card symbol or rod. The shaped instant piece can also have the shape of a lump shaped in any manner. A shaped instant piece is therefore coherent and not pulverulent, granular or grainy. It can be metered without further aids. The risk of fouling by spilt product and the risk of the wrong dosage are prevented.

In the context of the present invention, drying under vacuum is taken to mean drying, that is to say removal of liquid, at reduced atmospheric pressure, that is to say at a pressure below standard atmospheric pressure. In a preferred embodiment, drying is performed under vacuum in a vacuum drying apparatus into which the shaped instant composition is preferably introduced through a lock. The vacuum drying proceeds in a manner known per se. It is possible to use, for example, a vacuum cabinet or a vacuum belt dryer. For drying, use can be made of, for example, a contact dryer, a convection dryer or a microwave dryer. In a preferred variant, the drying proceeds under vacuum continuously, preferably with the use of a lock. In another preferred variant, the drying proceeds batchwise under vacuum, wherein, preferably, the vacuum dryer is charged under atmospheric pressure and is subsequently evacuated.

Preferably, drying proceeds at a vacuum of 10 mbar to 400 mbar, more preferably from 15 mbar to 100 mbar, or from 20 mbar to 90 mbar. In a preferred embodiment, drying proceeds just at a degree of vacuum at which the water withdrawn from the instant composition does not condense.

Preferably, the instant composition, in step c), is dried at a temperature of 20° C. to 110° C., particularly preferably at an elevated temperature of at least 40° C. to a maximum of 90° C.

The shaped instant composition is preferably dried under vacuum until a certain water content is achieved in the resultant shaped instant piece. Preferably, drying proceeds for one minute or more and two hours or less. Particularly preferably, drying proceeds for at least two minutes and at most 30 minutes.

In a preferred embodiment, the instant composition, in step a), is portioned before, during or after mixing. Particularly preferably, the instant composition, in step a), is portioned after mixing.

In an embodiment preferred according to the invention, the instant composition in step b) is shaped by introduction into a mold. In the present case a mold is taken to mean a mold for molding the pulverulent, granulated or grainy instant composition. A mold is an arrangement of at least one or a multiplicity of three-dimensional hollow vessels which, by their shape, preset the shape of the charged instant composition. A mold can have a closed vessel wall. Alternatively, the mold has a perforated vessel wall, for example a shaped fabric or screen net. The mold can, for example, have the shape of a cuboid, cube, cylinder, a lens, roller, a ring, egg, cone, tetrahedron, octahedron, rod or a playing card symbol. The mold can consist of a plurality of parts, in particular two parts, a lower base part and an upper base part, which are connected before or after filling the mold with the instant composition. For example, the mold can consist of two screen hemispheres of fabric. In a further embodiment, it is provided that the mold is in the form of a tool having means for ejecting the shaped instant products, for example ejecting die.

Preferably, the instant composition in step b) is shaped as a cuboid, cube, sphere, cylinder, lens, egg, ring, roller, cone, tetrahedron, octahedron, playing-card symbol or rod. Particularly preferably, the instant composition in step b) is shaped as a cuboid. In a further particularly preferred embodiment, the instant composition in step b) is shaped as a sphere.

In a preferred embodiment, the instant composition in step b) is compacted on shaping. Preferably, on compacting, a compression pressure of 0.1 to 20 bar, more preferably 2 to 6 bar, is exerted on the instant composition to be shaped. In another preferred variant, the instant composition is not compacted on shaping in step b).

In order to be able to shape and dry the instant composition, the instant composition must have a water content of at least 0.01% by weight, and a maximum of about 40% by weight, preferably up to a maximum of 30% by weight (based on the total weight).

It has surprisingly been found that the water content of the shaped instant composition has a decisive effect on the shaping of the instant piece during the drying under vacuum according to the invention. In a preferred embodiment, the shaped instant composition expands on the drying according to the invention in step c) to a larger volume so that an expanded shaped instant piece is obtained. This effect surprisingly occurs when the instant composition has a water content of at least 5% by weight and at maximum about 40% by weight, particularly preferably from 8 to 20% by weight (based on the total weight). According to the invention, the expansion behavior on drying, that is to say the degree of expansion, can be controlled, not only via the water content of the instant composition, but preferably in addition via the vacuum level on drying. A high vacuum leads to a more vigorous and further expansion, a low vacuum to a weaker expansion. The level of the vacuum to be applied for an appropriate expansion depends especially on the composition of the instant composition to be dried; as a matter of course, those skilled in the art can find for themselves the respective expedient vacuum level on drying by a few experiments, depending on composition and desired degree of expansion. According to the invention, the degree of expansion therefore always results especially from the interplay of the factors: total water content of the instant composition before drying and vacuum level on drying. Of course, the degree of expansion can be controlled to a certain extent by further shortened or prolonged drying times and thereby shortened or prolonged time of action of the vacuum. Those skilled in the art will find the respective expedient parameters by a few experiments.

The resultant expanded dried shaped instant piece has a higher volume and a low density. The density of a shaped instant piece produced in this manner can be so low that the instant piece can float on the liquid, that is to say for example water or milk. The floating shaped instant pieces disintegrate surprisingly quickly, wherein the disintegration process or the dissolution offers surprising optical effects and organoleptically attractive effects. For instance, on disintegration, for example, some foam can be formed. The foam can be produced with products such as cocoa and coffee which are produced from the shaped instant pieces by dissolution. For instance, it is possible, for example, by dissolving such a shaped instant piece in hot water to produce an instant coffee drink having a foam cap, what is termed “crème”.

In a further preferred embodiment, the instant composition retains its volume on drying in step c). A shaped instant composition which retains its volume on drying in step c) preferably has a water content of at least 0.01% by weight to a maximum of about 4.5% by weight (based on the total weight). From the abovementioned details, it is a matter of course that at limiting water contents from about 3 to about 5% by weight, by a correspondingly high vacuum on drying, nevertheless an expansion of the instant composition can be achieved; even at still lower water content, expansion is not completely excluded, but is not preferred and expedient.

If no expansion proceeds on drying the shaped instant composition under vacuum, the resultant shaped instant piece can have a high density, so that it does not float on the liquid, but, like a piece of sugar cubes, submerges in the liquid and sinks to the bottom.

Preferably, for drying, the instant composition shaped in step b), before step c), is separated from the mold. In a preferred alternative, the instant composition shaped in step b) remains for drying in step c) in the mold. The mold makes possible an expansion of the instant composition. This can be achieved by a mold not being completely filled with the instant composition with the vessel closed, having preferably a perforated vessel wall, or by the mold being extensible. In a likewise preferred alternative, the mold does not make expansion of the instant composition possible on drying. This can be achieved by, for example, a closed mold being completely filled with the instant composition and the mold not being extensible.

In a preferred embodiment, the instant composition, in step a), is set to a total water content of at least 0.01% by weight, and a maximum of about 40% by weight, preferably a maximum of about 30% by weight (based on the total weight) by mixing with a moist or water-containing component such as syrup or suspension and/or by mixing, spraying or vapor-deposition with a liquid, particularly preferably water. Preferably, the instant composition is set to the desired total water content by spraying with water. In a likewise preferred alternative, the instant composition is set to the desired total water content by vapor-deposition with water. In a likewise preferred alternative, the instant composition is set to the desired total water content by mixing with at least one water-containing component.

In a particularly preferred variant, the instant composition in step a) is set to a total water content of 0.01% by weight to a maximum of 4.5% by weight (based on the total weight), especially when volume expansion of the shaped instant composition is not desired during the vacuum drying.

In another particularly preferred variant, the instant composition in step a) is set to a total water content of at least 5 to a maximum of 40% by weight, preferably a maximum of 30% by weight (based on the total weight), especially when an expanded shaped instant piece is to be obtained.

In a further preferred embodiment, the instant composition provided and preferably mixed in step a) has a total water content according to the invention without further addition of water. In a preferred variant, the instant composition mixed in step a) has a total water content of 0.01 to 4.5% by weight without further addition of water. In another preferred variant, the instant composition mixed in step a) has a total water content of 5 to 40% by weight without further addition of water.

In a preferred embodiment, no disintegrant is added to the instant composition. Disintegrant is taken to mean a disintegration agent or disintegration aid which ensures rapid disintegration of, for example, tablets in a liquid. These are especially substances which increase the water absorption into the product, or gas-releasing substances, for example for effervescent tablets.

Advantageously, the process according to the invention also permits the portioning into one or more instant pieces of such instant compositions which, according to a conventional tableting process, do not permit direct tableting without further aids such as disintegrants or binders. Of course, it is also provided that at least one disintegrant known per se is added to the instant composition used according to the invention, in order to support further the rapid dissolution. Preference is given to gas-releasing substances which, furthermore, can improve the optical or organoleptic effect.

In a preferred embodiment, at least one binder is added to the instant composition, especially in order to affect shape, structure and dissolution behavior in a manner known per se. In a likewise preferred alternative, the instant composition is binder-free.

The instant product according to the invention is produced, for example, in such a manner that a defined amount of crystals of carrier substance which consists of sugar or sugar-like material is moistened and is mixed with a defined amount of the remaining ingredients in a suitable ratio. Thereafter, the mixture is brought into a mold and lightly pressed. Finally, the instant products are, for example, ejected from the molds and dried under suitable conditions. When the carrier substance is moistened, its surface becomes sticky, binds with the other food products and on being lightly pressed together in predetermined molds the desired shape of the instant product is achieved. The stickiness of the surface of crystals depends not only on the material properties of the carrier substance used, but also on the remaining ingredients. In the case of isomaltulose, the stickiness is very slight, which is due to the reduced solubility of isomaltulose. In any case, of the carrier substance crystals or agglomerates, a top layer is partially dissolved which can bind. By means of the subsequent drying, these interfacial surfaces are then bound. After the drying operation, the instant product obtains a stable form which does not dissolve until during preparation of the drink. The user must place, for example, water or milk into his cup or glass, add the, for example, tablet-shaped instant products into the glass and then mix the contents. The drink is ready to drink. The process according to the invention is distinguished, therefore, for example, in that crystalline sugars (such as sucrose, fructose, glucose, isomaltulose, maltose etc.) are moistened with water or a water-containing liquid, vapor or an aqueous aerosol and brought to a water content of 0.01-30% water. This concept also takes into account the use of, for example, juices or the like for producing instant cubes. Instead of crystalline sugar, use can also be made, for example, of amorphous or partially crystalline polysaccharides, oligosaccharides and also milk components and malt extracts. The moistened crystals are mixed, for example, with the remaining ingredients in a suitable ratio. Possibly, the total mixture can also be moistened as such. The mixture is then charged, for example, into a mold and lightly pressed, wherein the compression pressure can be very low. Subsequently, the products are, for example, ejected from the molds and dried under suitable conditions.

In a preferred embodiment, the instant composition is a food composition.

In a further preferred embodiment, the instant composition is a drug composition.

In a further preferred embodiment, the instant composition is a plant extract or essentially consists thereof.

The following quantitative data of the at least one component present according to the invention in the instant composition relates to the total dry matter content of the shaped instant piece produced. The weight fraction of the component in the water-containing shaped instant composition before drying can deviate therefrom. Those skilled in the art can, by simple calculation, or setting the drying loss conclude from the dry matter content the composition of the instant composition to be provided in step a) or obtained in step b), if appropriate after additional moistening.

Preferably, the instant composition contains at least one component which is selected from the group consisting of: drug, tea extract, coffee extract, fruit extract, malt extract, cocoa powder, aroma component, spice or spice mixture, preferably in the form of spice powder, soup mixture and mixtures thereof or consists predominantly thereof, preferably at 90% by weight or more.

For example, the instant composition contains food fibers, starch, polysaccharides, oligosaccharides, carbonates and/or milk components.

In a preferred embodiment, the instant composition contains at least one component selected from the group consisting of: sugars, sugar replacers, in particular sugar alcohols or sugar derivatives, intense sweeteners and mixtures thereof, or consists predominantly thereof, preferably at 90% by weight, 95% by weight, 98% by weight, 99.5% by weight, 99.7% by weight or more. Particularly preferably, the instant composition contains such a component as sole sweetening agent. Particularly preferably, the component is selected from the group consisting of: isomaltulose, isomaltose, trehalose, sucrose, glucose, fructose, maltose, lactose, inulin, leucrose, tagatose, oligofructose, starch, maltodextrins, isomalt, 1,1-GPM (1-O-α-D-glucopyranosyl-D-mannitol), 1, 6-GPS (6-O-α-D-glucopyranosyl-D-sorbitol), 1,1-GPS (1-O-α-D-glucopyranosyl-D-sorbitol), lactitol, maltitol, erythritol, xylitol, mannitol, sorbitol, maltitol syrup, hydrogenated and non-hydrogenated starch hydrolyzates and mixtures thereof, or consists predominantly thereof, preferably at 90% by weight, 95% by weight, 98% by weight, 99.5% by weight, 99.7% by weight or more.

Particularly preferably, the instant composition contains isomaltulose, particularly in a fraction of 10 to 95% by weight, 98% by weight, 99.5% by weight, 99.7% by weight or more, and preferably as sole sweetening agent. Particularly preferably, the instant composition contains isomaltose, particularly in a fraction of 10 to 95% by weight, and preferably as sole sweetening agent. Particularly preferably, the instant composition contains trehalose, particularly in a fraction of 10 to 95% by weight, 98% by weight, 99.5% by weight, 99.7% by weight or more, and preferably as sole sweetening agent. Particularly preferably, the instant composition contains sucrose, particularly in a fraction of 10 to 95% by weight, 98% by weight, 99.5% by weight, 99.7% by weight or more, and preferably as sole sweetening agent. Particularly preferably, the instant composition contains glucose, particularly in a fraction of 10 to 95% by weight, 98% by weight, 99.5% by weight, 99.7% by weight or more, and preferably as sole sweetening agent. Particularly preferably, the instant composition contains fructose, particularly in a fraction of 10 to 95% by weight, and preferably as sole sweetening agent. Particularly preferably, the instant composition contains maltose, particularly in a fraction of 10 to 95% by weight, 98% by weight, 99.5% by weight, 99.7% by weight or more, and preferably as sole sweetening agent. Particularly preferably, the instant composition contains lactose, particularly in a fraction of 10 to 95% by weight, 98% by weight, 99.5% by weight, 99.7% by weight or more, and preferably as sole sweetening agent. Particularly preferably, the instant composition contains inulin, particularly in a fraction of 10 to 95% by weight, 98% by weight, 99.5% by weight, 99.7% by weight or more, and preferably as sole sweetening agent. Particularly preferably, the instant composition contains leucrose, particularly in a fraction of 10 to 95% by weight, 98% by weight, 99.5% by weight, 99.7% by weight or more, and preferably as sole sweetening agent. Particularly preferably, the instant composition contains tagatose, particularly in a fraction of 10 to 95% by weight, 98% by weight, 99.5% by weight, 99.7% by weight or more, and preferably as sole sweetening agent. Particularly preferably, the instant composition contains oligofructose, particularly in a fraction of 10 to 95% by weight, 98% by weight, 99.5% by weight, 99.7% by weight or more, and preferably as sole sweetening agent.

Preferably, the instant composition contains at least one component which acts as carrier substance or structure-determining agent. In the context of the invention, the carrier substance has the task, especially, of supporting or forming the structure, that is to say the porous structure or matrix, of the shaped instant piece which essentially develops on drying the water-containing instant composition. Preferably, the carrier substance is water-soluble, in order to develop the structure. Preferably, the carrier substance is a non-hygroscopic substance. In an alternative preferred variant, the carrier substance possesses a predominantly or completely crystalline structure. Preferably, the carrier substance has predominantly or completely an amorphous structure. In addition, it is provided that the carrier substance is a pure substance or mixture and is present in part crystalline and part amorphous structure. It is provided in this case that a component having an originally crystalline structure develops an amorphous structure in the instant piece produced, and vice versa.

In a preferred embodiment, the structure-determining carrier substance is selected from the group consisting of: sugars, in particular isomaltulose, isomaltose, trehalose, sucrose, glucose, fructose, maltose, lactose, inulin, leucrose, tagatose, oligofructose; starch; maltodextrins; sugar alcohols or polyols, in particular isomalt, 1,1-GPM (1-O-α-D-glucopyranosyl-D-mannitol), 1, 6-GPS (6-O-α-D-glucopyranosyl-D-sorbitol), 1,1-GPS (1-O-α-D-glucopyranosyl-D-sorbitol), lactitol, maltitol, erythritol, xylitol, mannitol, sorbitol, maltitol syrup, and also hydrogenated and non-hydrogenated starch hydrolyzates and further polysaccharides, in particular polydextrose; oligo-saccharides, in particular inulin and oligofructose, and mixtures thereof. In a preferred embodiment, the at least one carrier substance present in the instant composition is isomaltulose, and particularly in a fraction of 10 to 95% by weight, preferably up to 98% by weight, 99.5% by weight, 99.7% by weight or more. In a further preferred embodiment, the at least one carrier substance present in the instant composition is isomaltose, and particularly in a fraction of 10 to 95% by weight, preferably up to 98% by weight, 99.5% by weight, 99.7% by weight or more. In a further preferred embodiment, the at least one carrier substance present in the instant composition is trehalose, and particularly in a fraction of 10 to 95% by weight, preferably up to 98% by weight, 99.5% by weight, 99.7% by weight or more. In a further preferred embodiment, the at least one carrier substance present in the instant composition is sucrose, and particularly in a fraction of 10 to 95% by weight, preferably up to 98% by weight, 99.5% by weight, 99.7% by weight or more. In a further preferred embodiment, the at least one carrier substance present in the instant composition is glucose, and particularly in a fraction of 10 to 95% by weight, preferably up to 98% by weight, 99.5% by weight, 99.7% by weight or more. In a further preferred embodiment, the at least one carrier substance present in the instant composition is fructose, and particularly in a fraction of 10 to 95% by weight, preferably up to 98% by weight, 99.5% by weight, 99.7% by weight or more. In a further preferred embodiment, the at least one carrier substance present in the instant composition is maltose, and particularly in a fraction of 10 to 95% by weight, preferably up to 98% by weight, 99.5% by weight, 99.7% by weight or more. In a further preferred embodiment, the at least one carrier substance present in the instant composition is lactose, and particularly in a fraction of 10 to 95% by weight, preferably up to 98% by weight, 99.5% by weight, 99.7% by weight or more. In a further preferred embodiment, the at least one carrier substance present in the instant composition is inulin, and particularly in a fraction of 10 to 95% by weight, preferably up to 98% by weight, 99.5% by weight, 99.7% by weight or more. In a further preferred embodiment, the at least one carrier substance present in the instant composition is leucrose, and particularly in a fraction of 10 to 95% by weight, preferably up to 98% by weight, 99.5% by weight, 99.7% by weight or more. In a further preferred embodiment, the at least one carrier substance present in the instant composition is tagatose, and particularly in a fraction of 10 to 95% by weight, preferably up to 98% by weight, 99.5% by weight, 99.7% by weight or more. In a further preferred embodiment, the at least one carrier substance present in the instant composition is oligo-fructose, and particularly in a fraction of 10 to 95% by weight, preferably up to 98% by weight, 99.5% by weight, 99.7% by weight or more.

In a preferred embodiment, the instant composition additionally contains soluble and/or insoluble fibers.

In a preferred embodiment, the instant composition contains at least one component selected from the group consisting of: food-compatible acids, food-compatible salts, intense sweeteners, minerals, trace elements, dietary fibers, antioxidants, stabilizers, thickeners, taste, aroma or odor substances, vitamins, dyes, sweetening agents and caffeine.

The invention also relates to novel shaped instant pieces which can be produced by the process according to the invention, that is to say are essentially characterized by the mode of production. Preferably, the shaped instant pieces of the invention are produced by the process of the invention.

The instant piece according to the invention consists of an instant composition as has been characterized above, or it is produced from this. As a matter of course the instant composition originally provided is not changed by the process of the invention in its further composition apart from in its water content. The above data on the composition thus also relate to the instant piece according to the invention. In particular, the instant composition and therefore the instant piece produced therefrom have at least one carrier substance which acts in a structure-determining manner and particularly forms the porous structure and matrix of the shaped instant piece. The instant piece therefore preferably contains at least one carrier substance which is selected from the group consisting of: isomaltulose, isomaltose, trehalose, sucrose, glucose, fructose, maltose, lactose, inulin, leucrose, tagatose, oligofructose, starch, maltodextrins, isomalt, 1,1-GPM (1-O-α-D-glucopyranosyl-D-mannitol), 1,6-GPS (6-O-α-D-glucopyranosyl-D-sorbitol), 1,1-GPS (1-O-α-D-glucopyranosyl-D-sorbitol), lactitol, maltitol, erythritol, xylitol, mannitol, sorbitol, maltitol syrup and mixtures thereof.

It has been found that a shaped instant piece according to the invention dissolves particularly well in a cold and/or hot liquid, and particularly is immediately soluble. In a preferred embodiment, the shaped instant piece according to the invention is immediately soluble in a cold liquid. In a preferred embodiment, the shaped instant piece according to the invention is immediately soluble in a hot liquid.

In a preferred embodiment, the shaped instant piece is characterized in that the size of the shaped instant piece is selected in such a manner that one defined portion, that is to say 1 to 5 pieces, gives one portion of cold or hot drink.

The shaped instant piece according to the invention is advantageously dimensionally stable and also storage stable before the specified dissolution in a liquid.

In a preferred embodiment, the shaped instant piece has a lower density than the liquid in which it is dissolved. Preferably, the shaped instant piece according to the invention floats on the liquid during the dissolution.

In a further preferred embodiment, the shaped instant piece has a higher density than the liquid in which it is dissolved. Preferably the shaped instant piece according to the invention, during the dissolution, submerges in a liquid and, in particular, sinks to the bottom of the vessel.

In a preferred embodiment, the liquid in which the shaped instant piece according to the invention is dissolved is aqueous. In a preferred embodiment, the liquid in which the shaped instant piece according to the invention is dissolved is water, an alcoholic drink, fruit juice, tea, coffee or milk. Advantageously, after the dissolution of the shaped instant piece, no further sweetening of the liquid is necessary.

The product consists, for example, of a crystalline sugar matrix which is infiltrated by other components. The crystalline matrix defines a three-dimensional network which stabilizes the shape of the product. Instead of a crystalline sugar matrix, the matrix can, for example, consist of other crystalline substances (sugar replacers) or of agglomerates of amorphously solidified components (sugars, sugar replacers, polysaccharides, oligosaccharides, malt extracts or milk components etc.). The composition and dosage of the product is selected, for example, in such a manner that one defined portion, that is to say 1-5 pieces of the product, gives one portion of cold or hot drink. The instant product is shaped, for example, in such a manner that the shape of the product is stable. Various shapes are possible, wherein the shapes share the fact that they have a base of any desired shape. The base is preferably planar, but can also have recesses or elevations. The basic shape then rises vertically or at a defined angle in height. The dimensions are freely selectable and are limited only by portion size and stability. The products, for example, have an outstanding cold- and hot-water solubility which, dependent on composition and mechanical action on dissolution, can be in the range of a few seconds to a few minutes. Instant products which have a suitable shape, for example cuboid, can then, for example, be individually wrapped. It is also possible to stack a plurality of products and package them as round or angular rods. The products are, for example, composed in such a manner that a coherent carrier mold is formed. The mold leads, for example, to the following approximate compositions: carrier substance fraction: 10-99%, extract fraction: 0.01-80%. The instant drinks according to the invention meet, for example, the following requirements: a) composed of support, aromas, extracts and also further functional or nutritional ingredients. b) portioned, individually packaged if necessary, shape variable (for example cuboid, circular or other shape). c) Hot- and cold-water soluble. The instant products according to the invention can of course also be suitable for other products, such as, for example, pudding, dessert creams, slightly sweet soups or sauces, or even mashed potato. For this, either sugars can be added which are less sweet, or else agglomerated starches/maltodextrins. The most important condition for our product is that it is prepared with water or another liquid (hot or cold). Whether the prepared product is subsequently drunk or eaten depends on the composition of the instant product and on the dosage or the dilution with water.

The invention also relates to an instant product having at least one soluble, preferably pulverulent, food product, characterized by at least one sugar-like carrier substance which is mixed with food product and bindable to it, and permits a defined shape of the instant product. In a preferred embodiment, the food product provided is in particular plant extracts. In a preferred embodiment, the food product consists of tea extract, coffee extract, fruit extract, malt extract, cocoa powder or the like. In a preferred embodiment, the instant product also has at least one of the following ingredients: aromas, thickeners, dyes, carbonates, intense sweeteners, dietary fibers, poly-saccharides, milk components, vitamins, minerals or the like. In a preferred embodiment, the carrier substance provided can be a crystalline sugar such as sucrose, fructose, glucose, isomaltulose, maltose, lactose etc., crystalline sugar replacers, polysaccharides, oligosaccharides. In a preferred embodiment, the instant product is characterized by a crystalline sugar matrix or a matrix consisting of other crystalline substances (sugar replacers) or of agglomerates of amorphously solidified components (sugars, sugar replacers, polysaccharides, oligosaccharides, malt extracts or milk components etc.) which is infiltrated by the other components. In a preferred embodiment, the instant product is characterized in that the composition and dosage of the product is selected in such a manner that one defined portion, that is to say 1-5 pieces of the product, gives one portion of cold or hot drink. In a preferred embodiment, the instant product is characterized in that the product, before its specified use, is dimensionally stable. In a preferred embodiment, the instant product is characterized in that the shape of the instant product is preferably a defined geometric figure, such as cylinder, pellet, cuboid, ring or the like. In a preferred embodiment, the instant product is characterized by cold- and/or hot-water solubility which, dependent on composition and mechanical action on dissolution, is in the range of a few seconds to a few minutes. In a preferred embodiment, the instant product is characterized in that the carrier substance fraction is 10-99%, while the extract fraction is 0.01-80%. The invention also relates to an instant product having at least one soluble, preferably pulverulent food product, characterized by a defined body of isomaltulose. In a preferred embodiment, the instant product is characterized in that it has the shape of a cube, cuboid, sphere or the like. The invention also relates to a process for producing an instant product, in particular an instant product according to the invention, characterized by the following steps: a) a defined amount of crystals of carrier substances is moistened and mixed with a defined amount of the remaining ingredients in the suitable ratio, b) the mixture is then introduced into a mold and lightly pressed, c) finally the instant products are ejected from the molds and dried under suitable conditions.

Further advantageous developments of the invention are given by the subclaims.

The invention will be described in more detail on the basis of the exemplary embodiments hereinafter without these being taken to be limiting.

### EXAMPLE 1

### Instant Coffee Pieces

### Shaped Playing Card Symbols

Components:

isomaltulose (crystalline),

freeze-dried coffee extract ground (ratio of isomaltulose to extract=2:1)

Process:

40 g of isomaltulose were held in a fine sieve over a vapor stream so that the isomaltulose crystals took up approximately 2.2-4.5% by weight of water. The moistened isomaltulose crystals were then homogeneously distributed by hand. Then 20 g of coffee extract were mixed in until all components were distributed evenly.

The shaping was then performed in a mold in which recesses in the shape of playing card symbols were introduced and had a base area of 2 to 2.25 cm². The mixture was charged into the mold and pressed by hand at a compression pressure of about 0.5 to 2.5 bar. The surface was then spread smooth. Then, the mold was turned and with the die forming the lower closure surface the pieces shaped as playing card symbols were pushed out of the mold. The pieces shaped as playing-card symbols were then dried in a vacuum cabinet for 1 to 1.5 hours at 80° C. and an absolute pressure of 134-67 mbar, cooled and subsequently packaged.

Processing Parameters:

moistening isomaltulose crystals: 2.2-4.5%,

compression pressure (manual): 0.5-2.5 bar,

surface area/piece: approximately 2-2.25 cm²

Drying Parameters:

90 min at 80° C.,

140-60 mbar absolute pressure

Weight Loss on Drying: 1.5-3.5% by Weight

### EXAMPLE 2

### Instant Tea Pieces

### Cubes, not Square, with Volume Expansion

Components:

sucrose (crystalline),

tea extract fennel-aniseed-cumin (ratio of isomaltulose to extract=8:1)

Process:

40 g of sugar were very lightly sprayed in a broad dish with a water aerosol, so that the crystal sugar took up approximately 6.8 to 11.0% by weight of water. The moistened sugar crystals were then homogeneously distributed by hand. Subsequently 5 g of tea extract were mixed in and the mixture was mixed until all the components were uniformly distributed.

Cube production was then performed in a mold as used, for example, for sugar cube production. The mass was charged into square recesses having a base area of 2 to 2.25 cm² and pressed by hand with a pressure of 0.2 to 0.8 bar. The protruding residues were then brushed off. Then the mold was turned and the cubes were pressed out of the mold by the die forming the lower closure surface. The cubes were then dried in a vacuum cabinet for 0.7 to 1.5 hours at 90° C. and an absolute pressure of 140 to 60 mbar. On drying, the volume of the cubes increased during drying as a function of the water content and the pressure, and the shape became rounder. The products were then cooled and subsequently packaged.

Processing Parameters:

moistening of sucrose: 6.8-11.0%,

compression pressure (manual): 0.5-0.8 bar,

surface area/piece: approximately 2-2.25 cm²

Drying Parameters:

40-90 min at 80-90° C.,

140-60 mbar absolute pressure

Weight Loss on Drying: 5.9-9.0%

### EXAMPLE 3

### Instant Tea Cubes Based on Isomaltulose

Component:

isomaltulose-aniseed tea extract

(ratio of isomaltulose to tea=8:1)

Processing Parameters:

moistening of isomaltulose: 2.3%,

compression pressure (press): 5 bar; surface area/piece: approximately 2.5 cm²,

Drying Parameters:

10 min at 90° C.,

20 mbar

Decomposition time (at 20° C.): 0.45 min

### EXAMPLE 4

### Instant Tea Cubes Based on Sucrose

Component:

sugar-aniseed tea extract

(ratio of sugar (sucrose) to tea=8:1)

Processing Parameters:

moistening of sucrose: 2%,

compression pressure (press): 5 bar,

surface area/piece: approximately 2.5 cm²

Drying Parameters:

10 min at 90° C.,

50 mbar

Decomposition time (at 20° C.): 2.3 min

### EXAMPLE 5

### Cocoa Bars Based on Isomaltulose

Components:

10% isomaltulose,

90% cocoa (commercial breakfast drink powder)

Processing Parameters:

moistening of isomaltulose: 6%,

compression pressure (press): 5 bar,

surface area/piece: approximately 2.5 cm²

Drying Parameters:

10 min at 90° C.,

20 mbar

Decomposition Time (at 20° C.): 1 min

### EXAMPLE 6

### Instant Coffee Cubes Based on Isomaltulose/Sucrose

Components:

60% isomaltulose/sugar mixture,

40% instant coffee

Processing Parameters:

moistening of isomaltulose/sugar: 4.5%,

compression pressure (press): 5 bar,

surface area/piece: approximately 2.5 cm²

Decomposition Time (at 20° C.): 0.40 min

### EXAMPLE 7

### Isomaltulose Cubes

100% isomaltulose,

Processing Parameters:

moistening of isomaltulose: 5%,

compacting pressure (press): 5 bar,

surface area/piece: approximately 2.5 cm²

Drying Parameters:

10 min at 90° C.,

20 mbar

Decomposition Time (at 20° C.): 1.10 min

### EXAMPLE 8

### Instant Breakfast Drink with Milk Powder Stick

Components:

sugar (sucrose), cocoa, milk powder in the ratio 4:3:2

Processing Parameters:

moistening of the sugar: 3%,

compression pressure (manual): 1 bar,

surface area/piece: approximately 2 cm²

Drying Parameters:

10 min at 80° C.,

40 mbar

Decomposition Time (at 20° C.): 0.20 min

### EXAMPLE 9

### Cocoa Lens

Component:

100% cocoa (commercial breakfast drink powder)

Processing Parameters:

moistening (commercial breakfast drink powder) to 16%

Drying Parameters:

20 min at 90° C.,

50 mbar

Decomposition Time (at 20° C.): 4 min

### EXAMPLE 10

### Comparison of the Dissolution Time for Shaped Instant Pieces (Cubes) According to the Invention and not According the Invention

Various shaped instant pieces were produced from different instant compositions. The shaped instant pieces were dried either under vacuum (according to the invention) or under atmospheric pressure (comparative examples).

### 10.1 Instant Isomaltulose Composition (2.5% Water)

40 g of isomaltulose (Palatinose®) were mixed with 1.00 g of water. Three batches of cubes were each shaped having a weight of 5 g and a pressure of 5 bar. The cubes were dried as described in table 1 (first three lines). The drying time depended on the final water content of the cubes.

TABLE 1

| | Cubes (according to | Cubes (comparative |
|---|---|---|
| | the invention) | example) |
| Temperature | 90° C. | 90° C. |
| Pressure | 20 mbar | 1013 mbar |
| Time | 10 minutes | 75 minutes |
| Weight of cubes 1 | 4.8015 | 4.9274 |
| Weight of cubes 2 | 4.7767 | 4.8688 |
| Weight of cubes 3 | 4.8344 | 4.8921 |
| Weight mean | 4.8042 | 4.8961 |
| WC cubes 1 | 5.14 | 5.15 |
| WC cubes 2 | 5.20 | 5.20 |
| WC cubes 3 | 5.13 | 5.17 |
| WC mean | 5.16 | 5.17 |
| DTM 1 cubes 1 | 25 seconds | 211 seconds |
| DTM 2 cubes 1 | 17 seconds | 67 seconds |
| DTM 1 cubes 2 | 25 seconds | 297 seconds |
| DTM 2 cubes 2 | 25 seconds | 177 seconds |
| Dissolution time | 23 seconds | 188 seconds |
| mean | | |

WC = water content; DTM = dissolution time measurement (at 20° C.)

### 10.2 Instant Isomaltulose Composition (5% Water)

40 g of isomaltulose (Palatinose®) were mixed with 2.00 g of water. Three batches of cubes were each shaped having a weight of 5 g and a pressure of 5 bar. The cubes were dried as described in table 2 (first three lines). The drying time depended on the final water content of the cubes.

TABLE 2

| | Cubes (according to | |
|---|---|---|
| | the invention) | Cubes (control) |
| Temperature | 90° C. | 90° C. |
| Pressure | 20 mbar | 1013 mbar |
| Time | 10 minutes | 75 minutes |
| Weight of cubes 1 | 4.7532 | 4.5776 |
| Weight of cubes 2 | 4.8499 | 4.5995 |
| Weight of cubes 3 | 4.7227 | 4.6327 |
| Weight mean | 4.7753 | 4.6048 |
| WC cubes 1 | 5.12 | 5.11 |
| WC cubes 2 | 5.09 | 5.10 |
| WC cubes 3 | 5.14 | 5.18 |
| WC mean | 5.12 | 5.13 |
| DTM 1 cubes 1 | 56 seconds | 350 seconds |
| DTM 2 cubes 1 | 67 seconds | 644 seconds |
| DTM 1 cubes 2 | 70 seconds | 653 seconds |
| DTM 2 cubes 2 | 89 seconds | 734 seconds |
| Dissolution time | 70 seconds | 595 seconds |
| mean | | |

WC = water content; DTM = dissolution time measurement (at 20° C.)

### 10.3 Instant Isomaltulose Ovomaltine® Composition (1.6% Water)

30 g of isomaltulose (Palatinose®) were mixed with 20 g of Ovomaltine® and 0.80 g of water. Three batches of cubes were each shaped having a weight of 3 g and a pressure of 3 bar. The cubes were dried as described in table 3 (first three lines). The drying time depended on the final water content of the cubes.

TABLE 3

| | Cubes (according to | |
|---|---|---|
| | the invention) | Cubes (control) |
| Temperature | 90° C. | 90° C. |
| Pressure | 20 mbar | 1013 mbar |
| Time | 10 minutes | 50 minutes |
| Weight of cubes 1 | 2.8514 | 2.7778 |
| Weight of cubes 2 | 2.8093 | 2.9120 |
| Weight of cubes 3 | 2.7819 | 2.9811 |
| Weight mean | 2.8142 | 2.8903 |
| WC cubes 1 | 5.17 | 5.06 |
| WC cubes 2 | 5.16 | 5.03 |
| WC cubes 3 | 5.14 | 5.09 |
| WC mean | 5.16 | 5.06 |
| DTM 1 cubes 1 | 20 seconds | 45 seconds |
| DTM 2 cubes 1 | 27 seconds | 39 seconds |
| DTM 1 cubes 2 | 27 seconds | 70 seconds |
| DTM 2 cubes 2 | 37 seconds | 48 seconds |
| Dissolution time | 27 seconds | 50 seconds |
| mean | | |

WC = water content; DTM = dissolution time measurement (at 20° C.); the control cubes adhered slightly to the mold

### 10.4 Instant Isomaltulose-Tea Extract Composition (2.85% Water)

30 g of isomaltulose (Palatinose®) were mixed with 5 g of tea extract and 0.70 g of water. Three batches of cubes were each shaped having a weight of 5 g and a pressure of 5 bar. The cubes were dried as described in table 4 (first three lines). The drying time depended on the final water content of the cubes.

TABLE 4

| | Cubes (according to | |
|---|---|---|
| | the invention) | Cubes (control) |
| Temperature | 90° C. | 90° C. |
| Pressure | 20 mbar | 1013 mbar |
| Time | 10 minutes | 50 minutes |
| Weight of cubes 1 | 4.6274 | 4.8803 |
| Weight of cubes 2 | 4.8188 | 4.7286 |
| Weight of cubes 3 | 4.7659 | 4.6096 |
| Weight mean | 4.7350 | 4.7395 |
| WC cubes 1 | 5.39 | 5.46 |
| WC cubes 2 | 5.37 | 5.50 |
| WC cubes 3 | 5.41 | 5.51 |
| WC mean | 5.39 | 5.49 |
| DTM 1 cubes 1 | 33 seconds | 304 seconds |
| DTM 2 cubes 1 | 45 seconds | 262 seconds |
| DTM 1 cubes 2 | 39 seconds | 477 seconds |
| DTM 2 cubes 2 | 70 seconds | 289 seconds |
| Dissolution time mean | 46 seconds | 333 seconds |

WC = water content; DTM = dissolution time measurement (at 20° C.)

### EXAMPLE 11

### Dissolution Time for Shaped Instant Pieces According to the Invention which Float on a Liquid

Shaped instant pieces according to the invention were produced which, on drying under vacuum, are expanded to a greater volume. These have a low density and float on water at the start of dissolution (float form). The following dissolution times were measured (at 20° C.):

shaped instant coffee piece: 70 seconds

shaped instant Ovomaltine® piece: 296 seconds

shaped instant tea piece: 250 seconds

### EXAMPLE 12

### Mold for Shaping a Shaped Instant Piece According to the Invention in Spherical Shape

The mold consists of two hollow hemispherical sieves which are formed of fabric. The hemispheres can be charged either in part or completely with an instant composition having a water content of 0.01% to 40% (based on the total weight). After they are charged, the hemispheres are mounted one over the other and held together by a closure plate. The mold containing the instant composition and consisting of two hemispheres is dried in a vacuum oven. If the two hemispheres of the mold were completely charged with the instant composition, a spherical instant piece of high density results. If the two hemispheres of the mold were not completely filled with the instant composition, the instant composition can expand on drying under vacuum. This produces asymmetrically shaped pieces of low density.

1. A process for producing a shaped instant piece of an instant composition, comprising the steps:
a) providing the instant composition, wherein the instant composition is pulverulent or is present in granule or grain form,
b) shaping the instant composition, wherein the instant composition, on shaping, has a water content of 0.01 to 40% by weight (based on the total weight), and
c) drying the shaped instant composition under vacuum,
wherein the instant composition contains a structure-determining carrier substance selected from the group consisting of sugars, sugar alcohols, polyols, hydrogenated and non-hydrogenated starch hydrolyzates, polysaccharides, oligosaccharides and mixtures thereof.

2. The process as claimed in claim 1, wherein the instant composition is mixed in step a) and if appropriate is portioned before, during or after mixing.

3. The process as claimed in claim 1, wherein the instant composition in step b) is shaped by introduction into a mold.

4. The process as claimed in claim 1, wherein the instant composition in step b) is shaped as a cuboid, cube, sphere, cylinder, rod, roller, lens, egg, ring, cone, tetrahedron, octahedron, or playing card symbol.

5. The process as claimed in claim 1, wherein, in step b), the instant composition is compacted on shaping.

6. The process as claimed in claim 5, wherein, in step b), the instant composition is compacted on shaping at a pressure of 0.1 to 20 bar.

7. The process as claimed in claim 1, wherein, in step b), the instant composition is not compacted on shaping.

8. The process as claimed in claim 3, wherein, before step c), the instant composition shaped in step b) is separated from the mold.

9. The process as claimed in claim 3, wherein, in step c), the instant composition shaped in step b) remains in the mold.

10. The process as claimed in claim 9, wherein, in step c), the mold makes possible an expansion of the instant composition.

11. The process as claimed in claim 1, wherein the instant composition contains at least one water-soluble component.

12. The process as claimed in claim 1, wherein, before step b), the instant composition is set to a water content of 0.01 to 40% by weight (based on the total weight) by mixing with water.

13. The process as claimed in claim 1, wherein, in step c), the instant composition is dried at a vacuum of 10 to 400 mbar.

14. The process as claimed in claim 1, wherein, in step c), the instant composition is dried at a temperature of 20 to 110° C.

15. The process as claimed in claim 1, wherein, in step c), the instant composition is expanded to a greater volume on drying.

16. The process as claimed in claim 15, wherein the instant composition, on shaping, has a water content of 5 to 40% by weight (based on the total weight).

17. The process as claimed in claim 1, wherein, in step c), the instant composition retains the volume on drying.

18. The process as claimed in claim 17, wherein the instant composition, on shaping, has a water content of 0.01 to 4.5% by weight (based on the total weight).

19. The process as claimed in claim 1, wherein the instant composition is a food composition.

20. The process as claimed in claim 1, wherein the instant composition is a drug composition.

21. The process as claimed in claim 1, wherein the instant composition contains at least one component carrier substance which is selected from the group consisting of: isomaltulose, isomaltose, trehalose, sucrose, glucose, fructose, maltose, lactose, inulin, leucrose, tagatose, oligofructose, starch, maltodextrins, isomalt, 1,1-GPM (1-O-α-D-glucopyranosyl-D-mannitol), 1,6-GPS (6-O-α-D-glucopyranosyl-D-sorbitol), 1,1-GPS (1-O-α-D-gluco-pyranosyl-D-sorbitol), lactitol, maltitol, erythritol, xylitol, mannitol, sorbitol, maltitol syrup and mixtures thereof.

22. The process as claimed in claim 21, wherein the component or the component mixture is present as carrier substance.

23. The process as claimed in claim 21, wherein the component or the component mixture is present as sweetening agent.

24. The process as claimed in claim 1, wherein the instant composition contains a component selected from the group consisting of: tea extract, coffee extract, fruit extract, malt extract, cocoa powder, spice powder, soup mixture and mixtures thereof.

25. The process as claimed in claim 1, wherein the instant composition contains at least one component selected from the group consisting of food-compatible acids, food-compatible salts, intense sweeteners, minerals, trace elements, dietary fibers, antioxidants, stabilizers, thickeners, taste, aroma or odor substances, vitamins, dyes, sweetening agents and caffeine.

26. A shaped instant piece which can be produced by the process as claimed in claim 1.

27. The shaped instant piece as claimed in claim 26, wherein the shaped instant piece is immediately soluble in a cold and/or hot liquid.

28. The shaped instant piece as claimed in claim 26, wherein the shaped instant piece, before dissolution, is dimensionally stable and storage stable.

29. The shaped instant piece as claimed in claim 26, wherein the shaped instant piece has a lower density than the liquid and floats on the liquid during dissolution.

30. The shaped instant piece as claimed in claim 26, wherein the shaped instant piece, during dissolution, has a higher density than the liquid and submerges in the liquid.
